(19) United States
(12) Patent Application Publication
(10) Pub. No.: US 2023/0084325 A1
(43) Pub. Date: Mar. 16, 2023

(54) RANDOM GREEDY ALGORITHM-BASED HORIZONTAL FEDERATED GRADIENT BOOSTED TREE OPTIMIZATION METHOD

(71) Applicant: ENNEW DIGITAL TECHNOLOGY CO., LTD., Langfang (CN)

(72) Inventors: Jinyi Zhang, Langfang (CN); Zhenfei Li, Langfang (CN)

(21) Appl. No.: 18/050,595

(22) Filed: Oct. 28, 2022

Related U.S. Application Data
(63) Continuation of application No. PCT/CN2021/101319, filed on Jun. 21, 2021.

(30) Foreign Application Priority Data
Jan. 14, 2021 (CN) 202110046246.2

(51) Int. Cl. G06N 20/20

(52) U.S. Cl. CPC G06N 20/20

(57) ABSTRACT

A horizontal federated Gradient Boosting Decision Tree optimization method based on a random greedy algorithm includes the following steps: the coordinator setting relevant parameters of a Gradient Boosting Decision Tree model, and sending them to each participant p_i; each participant segmenting the data set of a current node according to a segmentation feature f and a segmentation value v, and distributing the new segmentation data to child nodes. The supported horizontal federated learning includes participants and coordinators, wherein the participants have local data, the coordinators do not have any data, and the center for information aggregation of participants; participants calculate histograms separately and send them to the coordinators; after summarizing all histogram information, the coordinators find the optimal segmentation points according to the greedy algorithm, and then share them with respective participants to facilitate work with internal algorithms.

### CROSS REFERENCE TO RELATED APPLICATIONS

The present application is a Continuation application of PCT Application No. PCT/CN2021/101319 filed on Jun. 21, 2021, which claims the benefit of Chinese Patent Application No. 202110046246.2 filed on Jan. 14, 2021. All the above are hereby incorporated by reference in their entirety.

### TECHNICAL FIELD

The present application relates to the technical field of federated learning, in particular to a horizontal federated Gradient Boosting Decision Tree optimization method based on a random greedy algorithm.

### BACKGROUND

Federated learning is a machine learning framework, which can effectively help multiple organizations to model data usage and machine learning while meeting the requirements of user privacy protection, data security and government regulations, so that participants can jointly implement modeling on the basis of unshared data, which can technically break the data island and realize AI collaboration. Under this framework, the problem of collaboration among different data owners without exchanging data is solved by designing virtual models. A virtual model is the best model for all parties to aggregate data together. Each region serves the local target according to the model. Federated learning requires that the modeling results should be infinitely close to the traditional model, that is, the data of multiple data owners are gathered in one place for modeling. Under the federated mechanism, each participant has the same identity and status, and a data sharing strategy can be established. A greedy algorithm is a simpler and faster design technology for some optimal solutions. The characteristic of the greedy algorithm is that it is carried out step by step, often based on the current situation, the optimal selection is made according to an optimization measure, without considering all possible overall situations, which saves a lot of time that must be spent to exhaust all possibilities to find the optimal solution. The greedy algorithm adopts the top-down and iterative method to make successive greedy choices. Every time a greedy choice is made, the required problem is simplified to a smaller sub-problem. Through every greedy choice, an optimal solution of the problem can be obtained. Although the local optimal solution must be obtained in every step, the global solution generated therefrom is sometimes not necessarily optimal, so the greedy algorithm should not backtrack.

However, the existing horizontal federated Gradient Boosting Decision Tree algorithm requires each participant and coordinator to frequently transmit histogram information, which requires high network bandwidth of the coordinator, and the training efficiency is easily affected by the network stability. Moreover, because the transmitted histogram information contains user information, there is a risk of leaking user privacy. After introducing privacy protection solutions such as multi-party secure computing, homomorphic encryption and secret sharing, the possibility of user privacy leakage can be reduced, but the local computing burden will be increased and the training efficiency will be reduced.

### SUMMARY

The purpose of the present application is to provide a horizontal federated Gradient Boosting Decision Tree optimization method based on a random greedy algorithm, which aims to solve the problem that the existing horizontal federated Gradient Boosting Decision Tree algorithm proposed in the above background technology requires all participants and coordinators to frequently transmit histogram information, which has high requirements on the network bandwidth of the coordinators, and the training efficiency is easily affected by the network stability, and because the transmitted histogram information contains user information, there is a risk of leaking user privacy. After introducing privacy protection solutions such as multi-party secure computing, homomorphic encryption and secret sharing, the possibility of user privacy leakage can be reduced, but the local computing burden will be increased and the training efficiency will be reduced.

In order to achieve the above objectives, the present application provides the following technical solution: a horizontal federated Gradient Boosting Decision Tree optimization method based on a random greedy algorithm includes the following steps:

Step 1: a coordinator setting relevant parameters of a Gradient Boosting Decision Tree model, including a maximum number of decision trees T, a maximum depth of trees L, an initial predicted value base, etc., and sending the relevant parameters to respective participants pᵢ;

Step 2: letting a tree counter t=1;

Step 3: for each participant pᵢ, initializing a training target of a k^{th} tree yₖ=yₖ₋₁−ŷₖ₋₁; wherein y₀=y, ŷ₀=base;

Step 4: letting a tree layer counter l=1;

Step 5: letting a node counter of a current layer n=1;

Step 6: for each participant pᵢ, determining a segmentation point of a local current node n according to the data of the current node and an optimal segmentation point algorithm and sending the segmentation point information to the coordinator;

Step 7: the coordinator counting the segmentation point information of all participants, and determining a segmentation feature f and a segmentation value v according to an epsilon-greedy algorithm;

Step 8, the coordinator sending the finally determined segmentation information, including the determined segmentation feature f and segmentation value v, to respective participants;

Step 9: each participant segmenting a data set of the current node according to the segmentation feature f and the segmentation value v, and distributing new segmentation data to child nodes;

Step 10: letting n=n+1, and continuing with the Step 3 if n is less than or equal to a maximum number of nodes in the current layer; otherwise, proceeding to a next step;

Step 11: resetting the node information of the current layer according to the child nodes of a node of a l^{th} layer, so that l=l+1, and continuing with the Step 5 if l is less than or equal to the maximum tree depth L; otherwise, proceeding to a next step;

Step 12: letting t=t+1, and continuing with the Step 3 if t is greater than or equal to the maximum number of decision trees T; otherwise, ending.

Preferably, the optimal segmentation point algorithm in the Step 6:

I, determines a segmentation objective function, including but not limited to the following objective functions:

information gain: information gain is the most commonly used index to measure a purity of a sample set; assuming that there are K types of samples in a node sample set D, in which a proportion of a k^{th} type of samples is pₖ, an information entropy of D is defined as:

$$Ent ( D ) = - {\sum }_{k = 1}^{\vert K \vert} {p}_{k} {log}_{2} {p}_{k}$$

assuming that the node is segmented into V possible values according to an attribute a, the information gain is defined as:

$$Gain ( D , a ) = Ent ( D ) - {\sum }_{v = 1}^{V} \frac{\vert {D}^{v} \vert}{\vert D \vert} E n t ( {D}^{v} ) ;$$

information gain rate:

$$Gain\_ratio ( D , a ) = \frac{Gain ( D , a )}{IV ( a )}$$

$$where$$

$$IV ( a ) = - {\sum }_{v = 1}^{V} \frac{\vert {D}^{v} \vert}{\vert D \vert} {log}_{2} \frac{\vert {D}^{v} \vert}{\vert D \vert}$$

a Gini coefficient:

$$Gini ( D ) = {\sum }_{k = 1}^{\vert K \vert} {\sum }_{{k}^{′} \neq k} {p}_{k} {p}_{{k}^{′}} . \\ Gini\_index ( D , a ) = {\sum }_{v = 1}^{V} \frac{\vert {D}^{v} \vert}{\vert D \vert} Gini ( {D}^{v} )$$

a structural coefficient:

$$Gain = \frac{1}{2} ( \frac{{G}_{L}^{2}}{{H}_{L} + λ} + \frac{{G}_{R}^{2}}{{H}_{R} + λ} - \frac{{G}^{2}}{H + λ} ) - γ$$

where G_{L} is a sum of first-order gradients of the data set divided into a left node according to the segmentation point, H_{L} is a sum of second-order gradients of the data set of the left node, and G_{R} and H_{R} are sums of the gradient information of a corresponding right node, γ is a tree model complexity penalty term and X is a second-order regular term;

II, determines a candidate list of segmentation values: determining the list of segmentation values according to the data distribution of the current node, wherein the segmentation values comprise segmentation features and segmentation feature values; the list of segmentation value is determined according to the following method:

all values of all features in the data set;

determining a discrete segmentation point according to a value range of each feature in the data set; wherein the selection of the segmentation points can be evenly distributed within the value range according to the distribution of data, and the amount of data uniformly reflected between the segmentation points is approximately equal or a sum of the second-order gradients is approximately equal;

traversing the candidate list of segmentation values to find the segmentation point that makes the objective function optimal.

Preferably, the Epsilon greedy algorithm in the Step 7 includes: for the node n, each participant sending the node segmentation point information to the coordinator, including a segmentation feature fᵢ, a segmentation value vᵢ, a number of node samples Nᵢ and a local objective function gain gᵢ, where i represents respective participants;

according to the segmentation information of each participant and based on a maximum number principle, the coordinator determining an optimal segmentation feature fₘₐₓ, where X is a random number evenly distributed among [0,1] and randomly sampling X to obtain x; if x<=epsilon, randomly selecting one of the segmentation features of each participant as a global segmentation feature; otherwise, selecting fₘₐₓ as the global segmentation feature;

each participant recalculating the segmentation information according to the global segmentation feature and sending the segmentation information to the coordinator;

the coordinator determining a global segmentation value according to the following formula: if the total number of participants is P,

$$V = {\sum }_{i = 1}^{P} \frac{{N}_{i} {g}_{i}}{{\sum }_{j = 1}^{P} {N}_{j} {g}_{j}} {v}_{i} ;$$

distributing the segmentation value to each participant to perform node segmentation.

Preferably, the horizontal federated learning is a distributed structure of federated learning, in which each distributed node has the same data feature and different sample spaces.

Preferably, the Gradient Boosting Decision Tree algorithm is an integrated model based on gradient boosting and decision tree.

Preferably, the decision tree is a basic model of a Gradient Boosting Decision Tree model, and a prediction direction of a sample is judged at the node by given features based on a tree structure.

Preferably, the segmentation point is a segmentation position of non-leaf nodes in the decision tree for data segmentation.

Preferably, the histogram is statistical information representing the first-order gradient and the second-order gradient in node data.

Preferably, an input device can be one or more of data terminals such as computers and mobile phones or mobile terminals.

Preferably, the input device comprises a processor, and when executed by the processor, the algorithm of any one of steps 1 to 12 is implemented.

Compared with the prior art, the present application has the following beneficial effects: the horizontal federated Gradient Boosting Decision Tree optimization method based on a random greedy algorithm setting relevant parameters of a Gradient Boosting Decision Tree model, including but not limited to a maximum number of decision trees T, a maximum depth of trees L, an initial predicted value base, etc., and sending the relevant parameters to respective participants pᵢ; letting a tree counter t=1; for each participant pᵢ, letting a tree layer counter l=1; letting a node counter of a current layer n=1; for each participant pᵢ, determining a segmentation point of a local current node n according to the data of the current node and an optimal segmentation point algorithm and sending the segmentation point information to the coordinator; the coordinator counting the segmentation point information of all participants, and determining a segmentation feature f and a segmentation value v according to an epsilon-greedy algorithm; the coordinator sending the finally determined segmentation information, including but not limited to the determined segmentation feature f and segmentation value v, to respective participants; each participant segmenting a data set of the current node according to the segmentation feature f and the segmentation value v, and distributing new segmentation data to child nodes; letting n=n+1, and continuing with the Step 6 if n is less than or equal to a maximum number of nodes in the current layer; otherwise, proceeding to a next step; resetting the node information of the current layer according to the child nodes of a node of a l^{th} layer, so that l=l+1, and continuing with the Step 5 if l is less than or equal to the maximum tree depth L; otherwise, proceeding to a next step; letting t=t+1, and continuing with the Step 3 if t is greater than or equal to the maximum number of decision trees T; otherwise, ending. The supported horizontal federated learning includes participants and coordinators, wherein the participants have local data, the coordinators do not have any data, and the center for information aggregation of participants; participants calculate histograms separately and send them to the coordinators; after summarizing all histogram information, the coordinators find the optimal segmentation points according to the greedy algorithm, and then share them with respective participants to facilitate work with internal algorithms.

### BRIEF DESCRIPTION OF DRAWINGS

In order to explain the technical solution in the embodiments of the present application more clearly, the drawings necessary for the description of the embodiments or the prior art the following will be briefly introduced. Obviously, the drawings in the following description are only some embodiments of the present application, and for those skilled in the art, other drawings can be obtained according to these drawings without creative efforts.

FIG. 1 is a schematic diagram of the horizontal federated Gradient Boosting Decision Tree optimization method based on a random greedy algorithm of the present application;

FIG. 2 is a schematic diagram of the steps of the horizontal federated Gradient Boosting Decision Tree optimization method based on a random greedy algorithm of the present application;

FIG. 3 is a schematic diagram for judging the horizontal federated Gradient Boosting Decision Tree optimization method based on a random greedy algorithm of the present application.

### DESCRIPTION OF EMBODIMENTS

Next, the technical solutions in the embodiments of the present application will be clearly and completely described with reference to the drawings in the embodiments of the present application. Obviously, the described embodiments are only part of, not all of the embodiments of the present application. Based on the embodiments in the present application, all other embodiments obtained by those skilled in the art without creative work are within the scope of the present application.

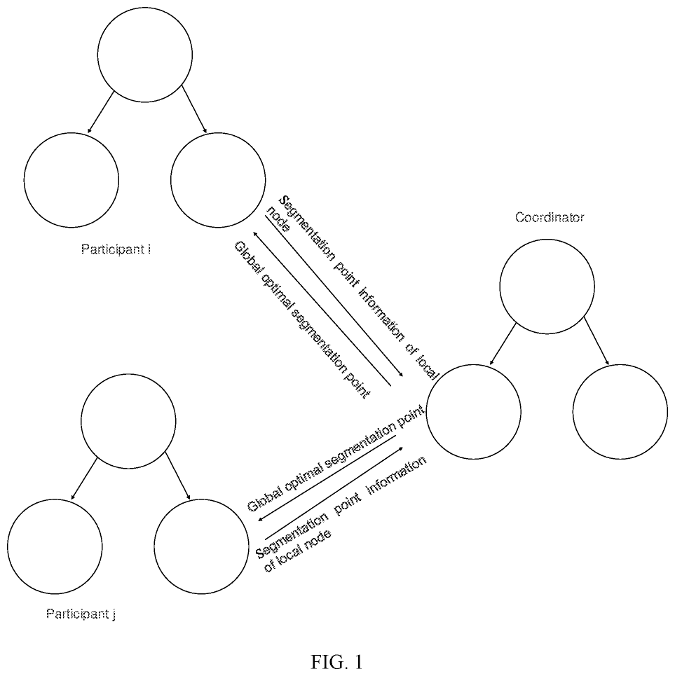

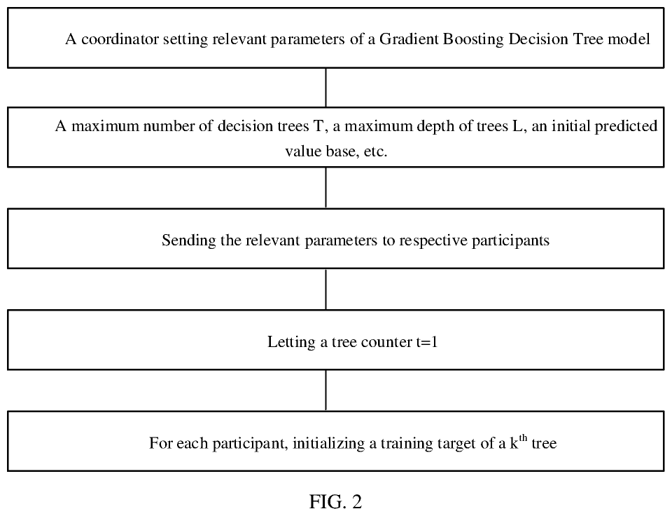

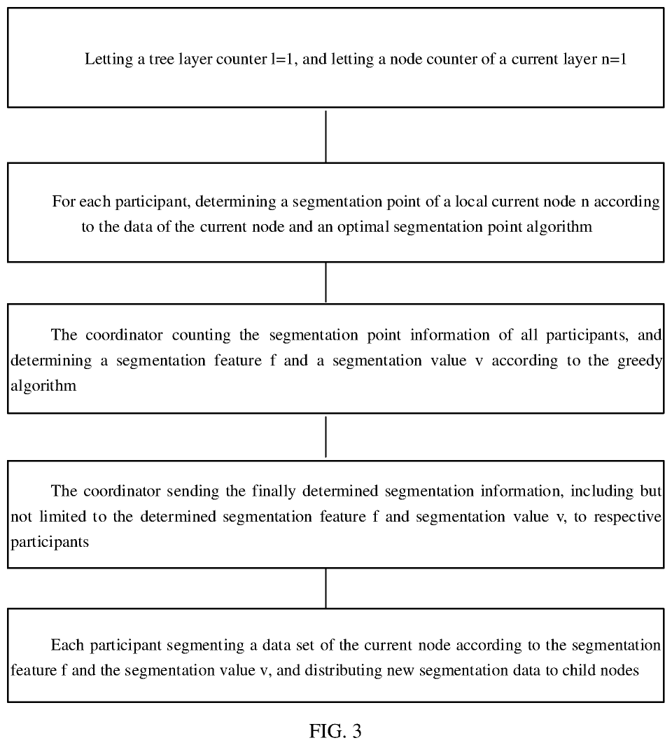

Referring to FIG. 1-3, the present application provides a technical solution: a horizontal federated Gradient Boosting Decision Tree optimization method based on a random greedy algorithm, which includes the following steps:

Step 1: a coordinator setting relevant parameters of a Gradient Boosting Decision Tree model, including a maximum number of decision trees T, a maximum depth of trees L, an initial predicted value base, etc., and sending the relevant parameters to respective participants pᵢ;

Step 2: letting a tree counter t=1;

Step 3: for each participant pᵢ, initializing a training target of a k^{th} tree yₖ−yₖ₋₁−ŷₖ₋₁; wherein y₀=y, ŷ₀=base;

Step 4: letting a tree layer counter l=1;

Step 5: letting a node counter of a current layer n=1;

Step 6: for each participant pᵢ, determining a segmentation point of a local current node n according to the data of the current node and an optimal segmentation point algorithm and sending the segmentation point information to the coordinator;

Step 7: the coordinator counting the segmentation point information of all participants, and determining a segmentation feature f and a segmentation value v according to an epsilon-greedy algorithm;

Step 8, the coordinator sending the finally determined segmentation information, including the determined segmentation feature f and segmentation value v, to respective participants;

Step 9: each participant segmenting a data set of the current node according to the segmentation feature f and the segmentation value v, and distributing new segmentation data to child nodes;

Step 10: letting n=n+1, and continuing with the Step 3 if n is less than or equal to a maximum number of nodes in the current layer; otherwise, proceeding to a next step;

Step 11: resetting the node information of the current layer according to the child nodes of a node of a l^{th} layer, so that l=l+1, and continuing with the Step 5 if l is less than or equal to the maximum tree depth L; otherwise, proceeding to a next step;

Step 12: letting t=t+1, and continuing with the Step 3 if t is greater than or equal to the maximum number of decision trees T; otherwise, ending.

Furthermore, the optimal segmentation point algorithm in the Step 6:

I, determines a segmentation objective function, including but not limited to the following objective functions:

information gain: information gain is the most commonly used index to measure a purity of a sample set; assuming that there are K types of samples in a node sample set D, in which a proportion of a k^{th} type of samples is pₖ, an information entropy of D is defined as:

$$Ent ( D ) = - {\sum }_{k = 1}^{\vert K \vert} {p}_{k} {log}_{2} {p}_{k}$$

assuming that the node is segmented into V possible values according to an attribute a, the information gain is defined as:

$$Gain ( D , a ) = Ent ( D ) - {\sum }_{v = 1}^{V} \frac{\vert {D}^{v} \vert}{\vert D \vert} E n t ( {D}^{v} ) ;$$

information gain rate:

$$Gain\_ratio ( D , a ) = \frac{Gain ( D , a )}{IV ( a )}$$

$$where$$

$$IV ( a ) = - {\sum }_{v = 1}^{V} \frac{\vert {D}^{v} \vert}{\vert D \vert} {log}_{2} \frac{\vert {D}^{v} \vert}{\vert D \vert}$$

a Gini coefficient:

$$Gini ( D ) = {\sum }_{k = 1}^{\vert K \vert} {\sum }_{{k}^{′} \neq k} {p}_{k} {p}_{{k}^{′}} \\ Gini\_index ( D , a ) = {\sum }_{v = 1}^{V} \frac{\vert {D}^{v} \vert}{\vert D \vert} Gini ( {D}^{v} )$$

a structural coefficient:

$$Gain = \frac{1}{2} ( \frac{{G}_{L}^{2}}{{H}_{L} + λ} + \frac{{G}_{R}^{2}}{{H}_{R} + λ} - \frac{{G}^{2}}{H + λ} ) - γ$$

where G_{L} is a sum of first-order gradients of the data set divided into a left node according to the segmentation point, H_{L} is a sum of second-order gradients of the data set of the left node, and G_{R} and H_{R} are sums of the gradient information of a corresponding right node, γ is a tree model complexity penalty term and X is a second-order regular term;

II, determines a candidate list of segmentation values: determining the list of segmentation values according to the data distribution of the current node, wherein the segmentation values comprise segmentation features and segmentation feature values; the list of segmentation value is determined according to the following method:

all values of all features in the data set;

determining a discrete segmentation point according to a value range of each feature in the data set; wherein the selection of the segmentation points can be evenly distributed within the value range according to the distribution of data, and the amount of data uniformly reflected between the segmentation points is approximately equal or a sum of the second-order gradients is approximately equal;

traversing the candidate list of segmentation values to find the segmentation point that makes the objective function optimal.

Furthermore, the Epsilon greedy algorithm in the Step 7 includes: for the node n,

each participant sending the node segmentation point information to the coordinator, including a segmentation feature fᵢ, a segmentation value vᵢ, a number of node samples Nᵢ and a local objective function gain gᵢ, where i represents respective participants;

according to the segmentation information of each participant and based on a maximum number principle, the coordinator determining an optimal segmentation feature fₘₐₓ,

where X is a random number evenly distributed among [0,1] and randomly sampling X to obtain x; if x<=epsilon, randomly selecting one of the segmentation features of each participant as a global segmentation feature; otherwise, selecting fₘₐₓ as the global segmentation feature;

each participant recalculating the segmentation information according to the global segmentation feature and sending the segmentation information to the coordinator;

the coordinator determining a global segmentation value according to the following formula: if the total number of participants is P,

$$v = {\sum }_{i = 1}^{P} \frac{{N}_{i} {g}_{i}}{{\sum }_{j = 1}^{P} {N}_{j} {g}_{j}} {v}_{i} ;$$

distributing the segmentation value to each participant to perform node segmentation.

Furthermore, the horizontal federated learning is a distributed structure of federated learning, in which each distributed node has the same data feature and different sample spaces, which can facilitate comparison work.

Furthermore, the Gradient Boosting Decision Tree algorithm is an integrated model based on gradient boosting and decision tree, which can facilitate work.

Furthermore, the decision tree is a basic model of a Gradient Boosting Decision Tree model, and a prediction direction of a sample is judged at the node by given features based on a tree structure, which can facilitate prediction.

Furthermore, the segmentation point is a segmentation position of non-leaf nodes in the decision tree for data segmentation, which can facilitate segmentation.

Furthermore, the histogram is statistical information representing the first-order gradient and the second-order gradient in node data, which can facilitate more intuitive representation.

Furthermore, an input device can be one or more of data terminals such as computers and mobile phones or mobile terminals, which can facilitate data input.

Furthermore, the input device comprises a processor, and when executed by the processor, the algorithm of any one of steps 1 to 12 is implemented.

The working principle is as below: Step 1: a coordinator setting relevant parameters of a Gradient Boosting Decision Tree model, including a maximum number of decision trees T, a maximum depth of trees L, an initial predicted value base, etc., and sending the relevant parameters to respective participants pᵢ; Step 2: letting a tree counter t=1; Step 3: for each participant pᵢ, initializing a training target of a k^{th} tree yₖ=yₖ₋₁−ŷₖ₋₁; wherein y₀=y, ŷ₀=base; Step 4: letting a tree layer counter l=1; Step 5: letting a node counter of a current layer n=1; Step 6: for each participant pᵢ, determining a segmentation point of a local current node n according to the data of the current node and an optimal segmentation point algorithm and sending the segmentation point information to the coordinator; I. I, determines a segmentation objective function, including but not limited to the following objective functions:

information gain: information gain is the most commonly used index to measure a purity of a sample set; assuming that there are K types of samples in a node sample set D, in which a proportion of a k^{th} type of samples is pₖ, an information entropy of D is defined as:

$$Ent ( D ) = - {\sum }_{k = 1}^{\vert K \vert} {p}_{k} {log}_{2} {p}_{k}$$

assuming that the node is segmented into V possible values according to an attribute a, the information gain is defined as:

$$Gain ( D , a ) = E n t ( D ) - {\sum }_{v = 1}^{V} \frac{\vert {D}^{v} \vert}{\vert D \vert} Ent ( {D}^{v} ) ;$$

information gain rate:

$$Gain\_ratio ( D , a ) = \frac{Gain ( D , a )}{I V ( a )}$$

$$where$$

$$IV ( a ) = - {\sum }_{v = 1}^{V} \frac{\vert {D}^{v} \vert}{\vert D \vert} {log}_{2} \frac{\vert {D}^{v} \vert}{\vert D \vert}$$

a Gini coefficient:

$$Gini ( D ) = {\sum }_{k = 1}^{\vert K \vert} {\sum }_{{k}^{′} \neq k} {p}_{k} {p}_{{k}^{′}} \\ Gini\_index ( D , a ) = {\sum }_{v = 1}^{v} \frac{\vert {D}^{v} \vert}{\vert D \vert} Gini ( {D}^{v} )$$

a structural coefficient:

$$Gain = \frac{1}{2} ( \frac{{G}_{L}^{2}}{{H}_{L} + λ} + \frac{{G}_{R}^{2}}{{H}_{R} + λ} - \frac{{G}^{2}}{H + λ} ) - γ$$

where G_{L} is a sum of first-order gradients of the data set divided into a left node according to the segmentation point, H_{L} is a sum of second-order gradients of the data set of the left node, and G_{R} and H_{R} are sums of the gradient information of a corresponding right node, γ is a tree model complexity penalty term and λ is a second-order regular term;

II, determines a candidate list of segmentation values: determining the list of segmentation values according to the data distribution of the current node, wherein the segmentation values comprise segmentation features and segmentation feature values; the list of segmentation value is determined according to the following method:

all values of all features in the data set;

determining a discrete segmentation point according to a value range of each feature in the data set; wherein the selection of the segmentation points can be evenly distributed within the value range according to the distribution of data, and the amount of data uniformly reflected between the segmentation points is approximately equal or a sum of the second-order gradients is approximately equal;

traversing the candidate list of segmentation values to find the segmentation point that makes the objective function optimal; Step 7: the coordinator counting the segmentation point information of all participants, and determining a segmentation feature f and a segmentation value v according to an epsilon-greedy algorithm; for the node n,

each participant sending the node segmentation point information to the coordinator, including a segmentation feature fᵢ, a segmentation value vᵢ, a number of node samples Nᵢ and a local objective function gain gᵢ, where i represents respective participants;

according to the segmentation information of each participant and based on a maximum number principle, the coordinator determining an optimal segmentation feature fₘₐₓ,

where X is a random number evenly distributed among [0,1] and randomly sampling X to obtain x; if x<=epsilon, randomly selecting one of the segmentation features of each participant as a global segmentation feature; otherwise, selecting fₘₐₓ as the global segmentation feature;

each participant recalculating the segmentation information according to the global segmentation feature and sending the segmentation information to the coordinator;

the coordinator determining a global segmentation value according to the following formula: if the total number of participants is P,

$$v = {\sum }_{i = 1}^{P} \frac{{N}_{i} {g}_{i}}{{\sum }_{j = 1}^{P} {N}_{j} {g}_{j}} {v}_{i} ;$$

distributing the segmentation value to each participant to perform node segmentation; Step 8, the coordinator sending the finally determined segmentation information, including the determined segmentation feature f and segmentation value v, to respective participants; Step 9: each participant segmenting a data set of the current node according to the segmentation feature f and the segmentation value v, and distributing new segmentation data to child nodes; Step 10: letting n=n+1, and continuing with the Step 3 if n is less than or equal to a maximum number of nodes in the current layer; otherwise, proceeding to a next step; Step 11: resetting the node information of the current layer according to the child nodes of a node of a l^{th} layer, so that l=l+1, and continuing with the Step 5 if l is less than or equal to the maximum tree depth L; otherwise, proceeding to a next step; Step 12: letting t=t+1, and continuing with the Step 3 if t is greater than or equal to the maximum number of decision trees T; otherwise, ending. The coordinator sets relevant parameters of a Gradient Boosting Decision Tree model, including but not limited to a maximum number of decision trees, a maximum depth of trees, an initial predicted value, etc., and sending the relevant parameters to respective participants; the coordinator sends the finally determined segmentation information, including but not limited to the determined segmentation feature and segmentation value, to all participants, and each participant segments the data set of the current node according to the segmentation feature and segmentation value. The supported horizontal federated learning includes participants and coordinators, wherein the participants have local data, the coordinators do not have any data, and the center for information aggregation of participants; participants calculate histograms separately and send them to the coordinators; after summarizing all histogram information, the coordinators find the optimal segmentation points according to the greedy algorithm, and then share them with respective participants to facilitate work with internal algorithms.

Although the embodiments of the present application have been shown and described, it will be understood by those skilled in the art that many changes, modifications, substitutions and variations can be made to these embodiments without departing from the principles and spirit of the present application, the scope of which is defined by the appended claims and their equivalents.

What is claimed is:

1. A horizontal federated Gradient Boosting Decision Tree optimization method based on a random greedy algorithm, comprising the following steps:
Step 1: a coordinator setting relevant parameters of a Gradient Boosting Decision Tree model, including a maximum number of decision trees T, a maximum depth of trees L, an initial predicted value base, etc., and sending the relevant parameters to respective participants pᵢ;
Step 2: letting a tree counter t=1;
Step 3: for each participant pᵢ, initializing a training target of a k^{th} tree yₖ=yₖ₋₁−ŷₖ₋₁; wherein y₀=y, ŷ₀=base;
Step 4: letting a tree layer counter l=1;
Step 5: letting a node counter of a current layer n=1;
Step 6: for each participant pᵢ, determining a segmentation point of a local current node n according to the data of the current node and an optimal segmentation point algorithm and sending the segmentation point information to the coordinator;
Step 7: the coordinator counting the segmentation point information of all participants, and determining a segmentation feature f and a segmentation value v according to an epsilon-greedy algorithm;
Step 8, the coordinator sending the finally determined segmentation information, including the determined segmentation feature f and segmentation value v, to respective participants;
Step 9: each participant segmenting a data set of the current node according to the segmentation feature f and the segmentation value v, and distributing new segmentation data to child nodes;
Step 10: letting n=n+1, and continuing with the Step 3 if n is less than or equal to a maximum number of nodes in the current layer; otherwise, proceeding to a next step;
Step 11: resetting the node information of the current layer according to the child nodes of a node of a l^{th} layer, so that l=l+1, and continuing with the Step 5 if l is less than or equal to the maximum tree depth L; otherwise, proceeding to a next step;
Step 12: letting t=t+1, and continuing with the Step 3 if t is greater than or equal to the maximum number of decision trees T; otherwise, ending.

2. The horizontal federated Gradient Boosting Decision Tree optimization method based on a random greedy algorithm according to claim 1, wherein the optimal segmentation point algorithm in the Step 3:
determines a segmentation objective function, including an objective function,
information gain: information gain is the most commonly used index to measure a purity of a sample set; assuming that there are K types of samples in a node sample set D, in which a proportion of a k^{th} type of samples is pₖ, an information entropy of D is defined as:
$$Ent ( D ) = - {\sum }_{k = 1}^{\vert K \vert} {p}_{k} {log}_{2} {p}_{k}$$
assuming that the node is segmented into V possible values according to an attribute a, the information gain is defined as:
$$Gain ( D , a ) = E n t ( D ) - {\sum }_{v = 1}^{V} \frac{\vert {D}^{v} \vert}{\vert D \vert} Ent ( {D}^{v} ) ;$$
information gain rate:
$$Gain\_ratio ( D , a ) = \frac{Gain ( D , a )}{IV ( a )} \\ IV ( a ) = - {\sum }_{v = 1}^{V} \frac{\vert {D}^{v} \vert}{\vert D \vert} {log}_{2} \frac{\vert {D}^{v} \vert}{\vert D \vert}$$
a Gini coefficient:
$$Gini ( D ) = {\sum }_{k = 1}^{\vert K \vert} {\sum }_{{k}^{′} \neq k} {p}_{k} {p}_{{k}^{′}} \\ Gini\_index ( D , a ) = {\sum }_{v = 1}^{V} \frac{\vert {D}^{v} \vert}{\vert D \vert} Gini ( {D}^{v} )$$
a structural coefficient:
$$Gain = \frac{1}{2} ( \frac{{G}_{L}^{2}}{{H}_{L} + λ} + \frac{{G}_{R}^{2}}{{H}_{R} + λ} - \frac{{G}^{2}}{H + λ} ) - γ$$
where G_{L} is a sum of first-order gradients of the data set divided into a left node according to the segmentation point, H_{L} is a sum of second-order gradients of the data set of the left node, and G_{R} and H_{R} are sums of the gradient information of a corresponding right node, γ is a tree model complexity penalty term and X is a second-order regular term;
determines a candidate list of segmentation values: determining the list of segmentation values according to the data distribution of the current node, wherein the segmentation values comprise segmentation features and segmentation feature values; the list of segmentation value is determined according to the following method:
all values of all features in the data set;
determining a discrete segmentation point according to a value range of each feature in the data set;
wherein the selection of the segmentation points can be evenly distributed within the value range according to the distribution of data, and the amount of data uniformly reflected between the segmentation points is approximately equal or a sum of the second-order gradients is approximately equal;
traversing the candidate list of segmentation values to find the segmentation point that makes the objective function optimal.

3. The horizontal federated Gradient Boosting Decision Tree optimization method based on a random greedy algorithm according to claim 1, wherein the Epsilon greedy algorithm in the Step 7 comprises:
for the node n, each participant sending the node segmentation point information to the coordinator, including a segmentation feature fᵢ, a segmentation value vᵢ, a number of node samples Nᵢ and a local objective function gain gᵢ, where i represents respective participants;
according to the segmentation information of each participant and based on a maximum number principle, the coordinator determining an optimal segmentation feature fₘₐₓ, where X is a random number evenly distributed among [0,1] and randomly sampling X to obtain x; if x<=epsilon, randomly selecting one of the segmentation features of each participant as a global segmentation feature; otherwise, selecting fₘₐₓ as the global segmentation feature;
each participant recalculating the segmentation information according to the global segmentation feature and sending the segmentation information to the coordinator;
the coordinator determining a global segmentation value according to the following formula: if the total number of participants is P,
$$v = {\sum }_{i = 1}^{P} \frac{{N}_{i} {g}_{i}}{{\sum }_{j = 1}^{P} {N}_{j} {g}_{j}} {v}_{i} ;$$
distributing the segmentation value to each participant to perform node segmentation.

4. The horizontal federated Gradient Boosting Decision Tree optimization method based on a random greedy algorithm according to claim 1, wherein the horizontal federated learning is a distributed structure of federated learning, in which each distributed node has the same data feature and different sample spaces.

5. The horizontal federated Gradient Boosting Decision Tree optimization method based on a random greedy algorithm according to claim 1, wherein the Gradient Boosting Decision Tree algorithm is an integrated model based on gradient boosting and decision tree.

6. The horizontal federated Gradient Boosting Decision Tree optimization method based on a random greedy algorithm according to claim 1, wherein the decision tree is a basic model of a Gradient Boosting Decision Tree model, and a prediction direction of a sample is judged at the node by given features based on a tree structure.

7. The horizontal federated Gradient Boosting Decision Tree optimization method based on a random greedy algorithm according to claim 1, wherein the segmentation point is a segmentation position of non-leaf nodes in the decision tree for data segmentation.

8. The horizontal federated Gradient Boosting Decision Tree optimization method based on a random greedy algorithm according to claim 1, wherein the histogram is statistical information representing the first-order gradient and the second-order gradient in node data.

9. The horizontal federated Gradient Boosting Decision Tree optimization method based on a random greedy algorithm according to claim 1, wherein an input device can be one or more of data terminals such as computers and mobile phones or mobile terminals.

10. The horizontal federated Gradient Boosting Decision Tree optimization method based on a random greedy algorithm according to claim 1, wherein the input device comprises a processor, and when executed by the processor, the algorithm of any one of steps 1 to 12 is implemented.
